(19) United States
(12) Patent Application Publication
(10) Pub. No.: US 2010/0045417 A1
(43) Pub. Date: Feb. 25, 2010

(54) Large current sensor

(76) Inventors: Xiao Dong Feng, Shanghai (CN); Yue Zhuo, Beijing (CN)

Correspondence Address: HARNESS, DICKEY & PIERCE, P.L.C., P.O.BOX 8910, RESTON, VA, 20195, US

(21) Appl. No.: 12/461,414

(22) Filed: Aug. 11, 2009

(30) Foreign Application Priority Data
Aug. 12, 2008 (CN) 200810210930.4

(51) Int. Cl. H01F 38/28

(52) U.S. Cl. 336/173

(57) ABSTRACT

A large current sensor is disclosed. In at least one embodiment, the large current sensor includes a primary coil and a secondary coil, wherein the primary coil is in a spiral form and forms a cavity, and the secondary coil is disposed in the cavity for producing an induced secondary voltage when a primary current flows in the primary coil. Advantages of the large current sensor of at least one embodiment of the present invention can include that it is simple in structure, safe in operation, and its out signal has high linearity and high accuracy and it can supply power to an electronic trip unit.

### PRIORITY STATEMENT

The present application hereby claims priority under 35U.S.C. §119 on Chinese patent application number CN 200810210930.4 filed Aug. 12, 2008, the entire contents of which are hereby incorporated herein by reference.

### FIELD

At least one embodiment of the present invention generally relates to a current measurement device and, particularly, to a large current sensor.

### BACKGROUND

Electronic trip units (ETU) have now been applied widely in intelligent low voltage circuit breakers (LVCB). When a fault current occurs, an electronic trip unit has to be able to send a trip signal to cut off a circuit, so as to protect the power line and electronic equipment.

In order to realize the above protection function of an electronic trip unit, it is necessary to make use of a large current measurement device to measure a current in power lines accurately regardless of whether the electronic equipment is operating normally or has a fault. In this case, the magnitude of the current may change in a very large range. Since the electronic trip unit will use the measured signal to calculate an accurate trip time so as to protect the power line and electronic equipment better, the measurement performed by the large current measurement device has to be very accurate. In order to prevent the circuit of an electronic trip unit from external interferences during its normal operation, an electrical isolation is also needed during the measurement. At the same time, when the large current measurement device is applied in a low voltage circuit breaker, such as a molded case circuit breaker (MCCB) or an air circuit breaker (ACB), it has to be capable of supplying power to the electronic trip unit via the power lines.

Referring to FIGS. 1 to 3, there are several large current measurement devices commonly used in the prior art.

FIG. 1 shows a structure of a current transformer (CT). The current transformer is a device widely utilized in low voltage circuit breakers to measure the large current and to supply power to the electronic trip units. As shown in the figure, the current transformer includes a primary coil 1, a secondary coil 2 and a ferromagnetic ring 3; the primary coil 1 is of a single-turn or multiple-turn structure, which passes through the ferromagnetic ring 3 and in which a large current flows; the secondary coil is of a multiple-turn structure (normally hundreds of turns or even more), and is wound on the ferromagnetic ring 3. According to Faraday's law of electromagnetic induction, the magnetic flux generated in the primary coil 1 varies in the ferromagnetic ring 3 and causes the generation of an induced electromotive force in the secondary coil 2, and when a load is connected to the secondary coil 2; its output current is determined by the following equation:

$${I}_{2} = \frac{{N}_{1}}{{N}_{2}} {I}_{1} ,$$

wherein, I₁ is the current in the primary coil, I₂ is the current in the secondary coil, N₁ is the number of turns of the primary coil, and N₂ is the number of turns of the secondary coil.

It can be seen that the current in the primary coil is in proportion to the current in the secondary coil, and their transforming ratio is determined by the turn ratio between the primary coil and secondary coil. Therefore, after a proper transforming ratio is selected, a large current in the primary coil can be transformed proportionally into a low current in the secondary coil.

The current transformers utilized in the low voltage circuit breakers can reach quite good accuracy in a certain current range, for example, a current less than six times the rated value, but in a higher current range its ferromagnetic ring will be saturated and result in a deteriorated linearity. In order to improve the linearity, a feasible method is to increase the cross-sectional area of the ferromagnetic ring, but this will lead to the case of using more materials and increasing the volume and manufacturing costs of the current transformer. Another defect of such a current transformer is that, when the secondary coil is in the open-loop state, the high voltage at its output end may put the safety of an operator's life at risk, and therefore it is necessary to take special measures, such as a ground connection and the like, to assure the safety of the operation.

FIG. 2 shows the principle of a Hall-effect current transducer. As shown in the figure, when a control current Ic flows longitudinally in a sheet of a conductive material, the mobile charge carriers of the current are affected by a Lorentz force vertical to the current direction generated by an external magnetic flux B and therefore are deflected, and when more and more deflected carriers gather at one transverse side of the conductive material sheet, an electric potential difference called Hall voltage V_{H} is generated. Numerous patent documents, for example U.S. Pat. Nos. 6,628,495, 6,005,383, 6,429,639, 5,923,162, 5,615,075, etc., have disclosed current transducers based on the above effect.

The Hall-effect current transducers have quite good linearity, quite high accuracy and quite wide bandwidth; however they are too expensive, bulky in volume, quite sensitive to the changes in the surrounding environment, vulnerable to the interferences of external electromagnetism, and their narrower applicable current range limits their applications in the low voltage circuit breakers, for example, even for a quite good Hall-effect current transducer, it is applicable only in the case of a current less than three times the rated current, which is much less than the current range required by a low voltage circuit breaker for the large current measurement device of its electronic trip unit to be able to measure.

A current shunt is also a common large current measurement device, which is a resistance connected in series in a main circuit, and when current flows through the resistance a voltage drop produced by the resistance can be measured by a voltage meter connected to the two ends of the resistance.

A manganin shunt is often applied to small currents, for example for the measurement of a current less than 200A, and in such a current range, the manganin shunt provides good cost-effectiveness: providing a relatively high linearity and accuracy on the basis of lower costs. However, the serial connection mode limits the use of a manganin shunt in measuring large currents; furthermore it does not have electrical insulation, so that in a case of high frequency it is necessary to take into consideration the influence on the measurement results caused by phase changes induced by the self-induction of the shunt.

FIG. 3 shows a structure of a Rogowski coil. As shown in the figure, the Rogowski coil is wound on a non-magnetic frame, and when a conductor carrying a current passes through the Rogowski coil, it would generate in the Rogowski coil a voltage signal proportional to its mutual inductance value M and the current's time change rate

$$\frac{d i ( t )}{d t} :$$

$${e}_{0} ( t ) = M \frac{d i ( t )}{d t}$$

wherein, i(t) is a primary current.

It obtains a current:

$$i ( t ) = \frac{1}{M} \int {e}_{0} ( t ) d t .$$

Numerous patent documents, such as U.S. Pat. Nos. 7,106,162, 6,064,191, 6,018,239, etc., have disclosed large current measurement devices based on the above principle.

The Rogowski coil has quite good linearity, quite wide a bandwidth, quite wide an induction range and good electrical insulation. However, when the primary current is relatively small, the output signal of the Rogowski coil is comparatively weak, and the manner for winding its secondary coil is quite complicated and tends to affect the measurement accuracy. Therefore it needs to add an integrator to process its output signals, and furthermore the Rogowski coil cannot supply power to the electronic trip unit as a current transformer does.

### SUMMARY

In view of the situation, at least one embodiment of the present invention provides a large current sensor which is simple in structure, safe in operation, and the out signals of which have a high linearity and high accuracy and can supply power to the electronic trip units.

At least one embodiment of the present invention is directed to a large current sensor, comprising a primary coil and a secondary coil, wherein the primary coil is in a spiral form and forms a cavity, and the secondary coil is disposed in the cavity for producing an induced secondary voltage when a primary current flows in the primary coil.

According to one aspect of at least one embodiment of the present invention, a rapid saturation current transformer is provided at one end of the primary coil.

According to one aspect of at least one embodiment of the present invention, the cavity extends along the direction of the spiral axis of the spiral primary coil.

According to one aspect of at least one embodiment of the present invention, the spiral primary coil is formed by twisting a copper busbar.

According to one aspect of at least one embodiment of the present invention, the primary coil is a single-turn or multiple-turn coil.

According to one aspect of at least one embodiment of the present invention, the secondary coil is a multiple-turn coil.

According to one aspect of at least one embodiment of the present invention, the secondary coil is an air core coil, or one wound on a non-ferromagnetic core.

The large current sensor of at least one embodiment of the present invention can achieve the following technical effects by the above construction:

Its structure is simple.

Its operation is safe and reliable.

It can supply power to an electronic trip unit.

Its output signal always maintains a good linearity and accuracy over quite wide a range of the primary current.

The amplitude of its output signal meets the requirements of the circuits for subsequent signal processing, and the size thereof can be adjusted by adjusting the number of turns of the secondary coil and the value of the load resistance.

It is particularly suitable to the measurement of a large current.

### BRIEF DESCRIPTION OF THE DRAWINGS

FIGS. 1 to 3 are schematic diagrams of several currently available large current measurement devices;

FIG. 4 is a schematic structural diagram of a primary coil of a large current sensor of an embodiment of the present invention;

FIG. 5 is a schematic diagram of the direction and distribution of internal magnetic flux in the primary coil in FIG. 4 when it is energized;

FIG. 6 is a schematic structural diagram of a particular embodiment of the large current sensor of an embodiment of the present invention;

FIG. 7 is a diagram of the principle of the circuit for testing the signal linearity and accuracy of the large current sensor of an embodiment of the present invention;

FIG. 8 is a diagram of the primary current versus the secondary voltage of each set of tests for testing the signal linearity of the large current sensor of an embodiment of the present invention by using the circuit in FIG. 7;

FIG. 9 is a diagram of the primary current versus the secondary voltage in each of the tests under the condition that the load resistance in FIG. 8 is 1004 Ohm;

FIG. 10 is a diagram of the primary current versus the secondary voltage in each of the tests under the condition that the load resistance in FIG. 8 is 75.1 Ohm;

FIG. 11 is a diagram of the primary current versus the secondary voltage in each of the tests under the condition that the number of turns of the secondary coil in FIG. 8 is 600 turns;

FIG. 12 is a diagram of the primary current versus the secondary voltage in each of the tests under the condition that the number of turns of the secondary coil in FIG. 8 is 400 turns;

FIG. 13 is a diagram of the primary current versus the secondary voltage in each of the tests under the condition that the number of turns of the secondary coil in FIG. 8 is 200 turns;

FIG. 14 is a diagram of the primary current versus the secondary voltage for testing the signal linearity of a currently available current transformer; and

FIG. 15 is a diagram of the primary current versus error for testing the signal accuracy of the large current sensor of an embodiment of the present invention by using the circuit in FIG. 7, and a diagram of the primary current versus error of a currently available current transformer.

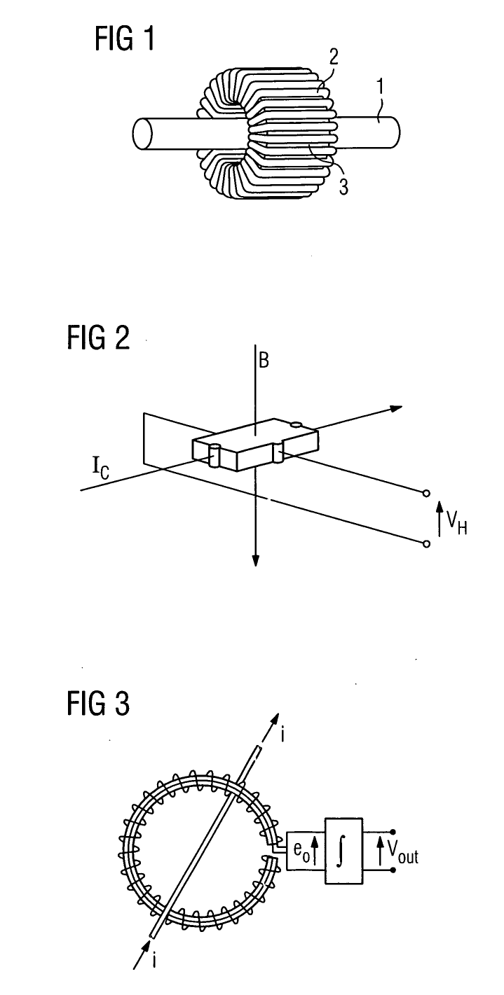

### DETAILED DESCRIPTION OF THE EXAMPLE EMBODIMENTS

Various example embodiments will now be described more fully with reference to the accompanying drawings in which only some example embodiments are shown. Specific structural and functional details disclosed herein are merely representative for purposes of describing example embodiments. The present invention, however, may be embodied in many alternate forms and should not be construed as limited to only the example embodiments set forth herein.

Accordingly, while example embodiments of the invention are capable of various modifications and alternative forms, embodiments thereof are shown by way of example in the drawings and will herein be described in detail. It should be understood, however, that there is no intent to limit example embodiments of the present invention to the particular forms disclosed. On the contrary, example embodiments are to cover all modifications, equivalents, and alternatives falling within the scope of the invention. Like numbers refer to like elements throughout the description of the figures.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of example embodiments of the present invention. As used herein, the term “and/or,” includes any and all combinations of one or more of the associated listed items.

It will be understood that when an element is referred to as being “connected,” or “coupled,” to another element, it can be directly connected or coupled to the other element or intervening elements may be present. In contrast, when an element is referred to as being “directly connected,” or “directly coupled,” to another element, there are no intervening elements present. Other words used to describe the relationship between elements should be interpreted in a like fashion (e.g., “between,” versus “directly between,” “adjacent,” versus “directly adjacent,” etc.).

The terminology used herein is for the purpose of describing particular embodiments only and is not intended to be limiting of example embodiments of the invention. As used herein, the singular forms “a,” “an,” and “the,” are intended to include the plural forms as well, unless the context clearly indicates otherwise. As used herein, the terms “and/or” and “at least one of” include any and all combinations of one or more of the associated listed items. It will be further understood that the terms “comprises,” “comprising,” “includes,” and/or “including,” when used herein, specify the presence of stated features, integers, steps, operations, elements, and/or components, but do not preclude the presence or addition of one or more other features, integers, steps, operations, elements, components, and/or groups thereof.

It should also be noted that in some alternative implementations, the functions/acts noted may occur out of the order noted in the figures. For example, two figures shown in succession may in fact be executed substantially concurrently or may sometimes be executed in the reverse order, depending upon the functionality/acts involved.

Spatially relative terms, such as “beneath”, “below”, “lower”, “above”, “upper”, and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, term such as “below” can encompass both an orientation of above and below. The device may be otherwise oriented (rotated 90 degrees or at other orientations) and the spatially relative descriptors used herein are interpreted accordingly.

Although the terms first, second, etc. may be used herein to describe various elements, components, regions, layers and/or sections, it should be understood that these elements, components, regions, layers and/or sections should not be limited by these terms. These terms are used only to distinguish one element, component, region, layer, or section from another region, layer, or section. Thus, a first element, component, region, layer, or section discussed below could be termed a second element, component, region, layer, or section without departing from the teachings of the present invention.

The present invention will be explained in detail hereinbelow in conjunction with the drawings.

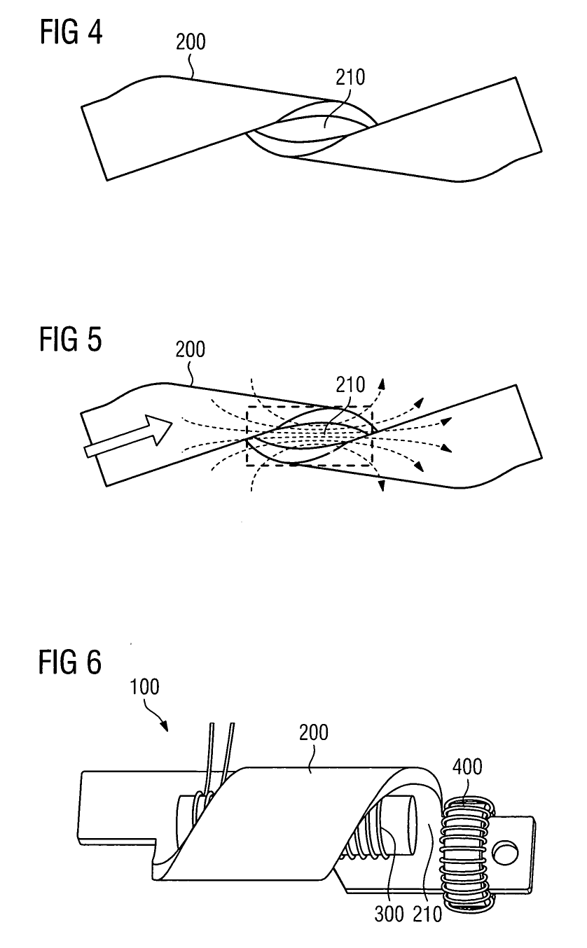

Referring to FIGS. 4 to 6, the large current sensor 100 of an embodiment of the present invention has a simple structure, and it comprises a primary coil 200 and a secondary coil 300, and preferably also comprises a rapid saturation current transformer 400.

The primary coil 200 is in a spiral shape formed by twisting a copper busbar, and extends along the direction of the spiral axis to forms a cavity 210. The number of turns of the primary coil 200 is single-turn or multiple-turn. When an alternating current (hereinafter referred to as “current”) flows in the primary coil 200, an alternating magnetic flux will be generated therein, and the direction of the current and magnetic flux follows the right-hand rule. Referring specifically to FIG. 5, it can be judged by the right-hand rule that the magnetic flux generated in the spiral primary coil 200 concentrates in its cavity 210, as shown by the dashed line box in the figure, and distributes substantially along the direction of the spiral axis. The density of the magnetic flux is in proportion to the primary current passing the primary coil 200. Therefore, the magnitude of the primary current can be known by measuring the magnetic flux density in the cavity 210.

The secondary coil 300 is a multiple-turn air core coil or a coil wound on a non-ferromagnetic core, and FIG. 6 specifically shows the case that the secondary coil 300 is a coil wound on a non-ferromagnetic core. The secondary coil 300 is disposed in the cavity 210 of the primary coil 200. When the alternating magnetic flux, generated after having the primary coil 200 energized, passes through the secondary coil 300, an induced electromotive force is generated in the secondary coil 300. In the above case that the secondary coil 300 is an air core coil or a coil wound on a non-ferromagnetic core, even in the case that the primary current is an extremely large current, the saturated state will not occur in the air core or non-ferromagnetic core, and this means that the magnitude of the primary current within quite wide a current range can be measured with a very good linearity.

In the case of an open loop, the relationship between the induced electromotive force E and the output voltage U in the secondary coil 300 can be determined by the following equation:

U=E=4.44fNΦₘ,

wherein E is the induced electromotive force, U is the secondary voltage outputted by the secondary coil 300, N is the number of turns of the secondary coil 300, Φₘ is maximum value of the magnetic flux generated after having the primary coil 200 energized, and when the magnitude of the magnetic flux varies in a sinusoidal manner, the value of Φₘ is \sqrt{2} times the effective magnetic flux Φ, and f is the current's frequency.

It can be seen from the above equation that, when the number of turns of the secondary coil 300 is determined, its outputted secondary voltage is relevant with only the current's frequency (normally a constant) and the magnitude of the magnetic flux.

The proportional relationship between the primary current in the primary coil 200 and the secondary voltage of the secondary coil 300 is as follows:

$$I {∝}^{F = Nl} F {∝}^{F = \sum Hl} H {∝}^{B = μ H} B {∝}^{Φ = BS} Φ ( {Φ}_{m} ) {∝}^{E = 4.44 fN {Φ}_{m}} E = U ,$$

wherein I is the primary current, F is the magnetomotive force, H is the magnetic field intensity, l is the length of magnetic circuit, B is the magnetic induction intensity, μ is the magnetic permeability, S is the cross-sectional area of the ferromagnetic material, and in the above equation, the equations above the directly proportional symbol ∝ are the theoretical basis to derive the fact that the parameters before and after the directly proportional symbol are in direct proportion.

It can be seen from the above equation that the secondary voltage U outputted by the secondary coil 300 is in proportion to the primary current I of the primary coil 200, and the magnitude of primary current in the primary coil 200 can be deduced by measuring the secondary voltage outputted by the secondary coil 300.

Since the output signal of the large current sensor of an embodiment of the present invention is a voltage signal rather than the current signal in a currently available current transformer, the secondary coil will not endanger the safety of an operator's life even when it is in an open-loop state, and therefore the operation is very safe and reliable.

In order to supply power to an electronic trip unit, a rapid saturation current transformer 400 is provided at one end of the primary coil 200, and preferably one end of the primary coil 200 passes through the rapid saturation current transformer 400. Such a rapid saturation current transformer 400 has been widely used in a variety of air circuit breaker products. The output voltage of the secondary coil 300 increases proportionally with the increase of the primary current, and since the rapid saturation current transformer 400 is saturated in the case of a lower primary current, it will not increase proportionally with the continuous increase of the primary current, so that the rapid saturation current transformer 400 can perform the voltage regulation on the output voltage in the case of a high primary current, thus supplying power to the electronic trip unit in a reliable and stable way. Since the rapid saturation current transformer is a currently available and mature product, its functional principles will not be described herewith redundantly.

Those skilled in the art can understand that separate electronic devices can also be used to supply power to the electronic trip unit.

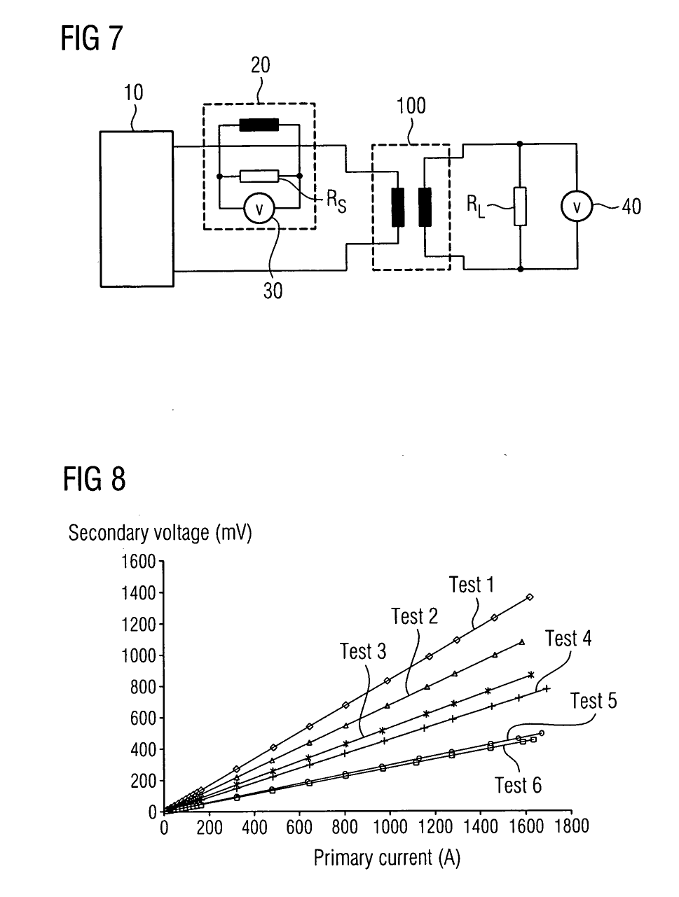

In order to study the linearity and accuracy of the large current sensor of the present invention, the applicant has performed various tests. FIG. 7 is a principle circuit diagram for testing the signal's linearity and accuracy of the large current sensor of an embodiment of the present invention, wherein a large current generator 10 generates a large current which flows into the large current sensor 100 of an embodiment of the present invention, and in order to improve the accuracy of the tests, a standard current transformer 20 with a precision 0.01% is provided between the large current generator 10 and large current sensor 100 of an embodiment of the present invention for carrying out the calibration; the resistance Rs of the standard current transformer 20 is 1 ohm, and the two ends thereof are connected to a universal meter 30 for measuring the output current of the standard current transformer 20, which is used as a primary current in the tests. The secondary coil 300 (not shown) of the large current sensor 100 of an embodiment of the present invention is connected to a load resistance R_{L}, and in different sets of tests, an air core structure is adopted for the secondary coil 300, with the number of turns being 600 turns, 400 turns, 200 turns respectively, the value of the load resistance R_{L} is taken respectively as 75.1 Ohm and 1004 Ohm, and two ends of the load resistance R_{L} are connected to a universal meter 40 for measuring the output voltage, which is used as the secondary voltage in the tests.

The testing was carried out in six sets of tests, with the conditions of each set of tests shown in the following table:

TABLE 1
Conditions of each set of tests

| | The number of turns in | | | The value of the load | |
|---|---|---|---|---|---|
| Each set | the secondary coil (Turn) | | | resistance R_{L} (Ohm) | |
| of tests | 600 | 400 | 200 | 1004 | 75.1 |
| Test 1 | ✓ | | | ✓ | |
| Test 2 | ✓ | | | | ✓ |
| Test 3 | | ✓ | | ✓ | |
| Test 4 | | ✓ | | | ✓ |
| Test 5 | | | ✓ | ✓ | |
| Test 6 | | | ✓ | | ✓ |

Taking Test 1 as an example, it can be seen from Table 1 that the conditions of this set of tests are that the number of turns of the secondary coil is 600 turns, and the value of the load resistance connected to the secondary coil is 1004 Ohm. The conditions of the other sets of tests can be learnt from Table 1 in the same way.

The results of each set of tests:

TABLE 2
the results of Test 1

| Primary current (A) | Secondary voltage (mV) | Error (%) |
|---|---|---|
| 16 | 13.6 | 0.52% |
| 32.2 | 27.2 | −0.10% |
| 47.8 | 40.5 | 0.20% |
| 64 | 54.5 | 0.71% |
| 80.2 | 68.2 | 0.56% |
| 96 | 81.3 | 0.15% |
| 112.8 | 95.6 | 0.23% |
| 127.2 | 107.9 | 0.32% |
| 145.2 | 123 | 0.18% |
| 160.2 | 135.7 | 0.17% |
| 319.2 | 269.5 | −0.15% |
| 483.6 | 406.9 | −0.50% |
| 642 | 546 | 0.58% |
| 799 | 679 | 0.50% |
| 986 | 836 | 0.27% |
| 1169 | 990 | 0.15% |
| 1291 | 1092 | 0.03% |
| 1460 | 1233 | −0.13% |
| 1614 | 1361 | −0.28% |

TABLE 3
the results of Test 2

| Primary current (A) | Secondary voltage (mV) | Error (%) |
|---|---|---|
| 16 | 11.3 | 2.59% |
| 32.2 | 22.8 | 2.86% |
| 47.6 | 33.6 | 2.54% |
| 64 | 45.3 | 2.82% |
| 80 | 56.4 | 2.41% |
| 96.2 | 67.8 | 2.38% |
| 113.2 | 79.7 | 2.28% |
| 129.2 | 90.9 | 2.20% |
| 146.2 | 102.8 | 2.14% |
| 160.6 | 112.8 | 2.03% |
| 320.8 | 224.2 | 1.52% |
| 477 | 331.5 | 0.95% |
| 641 | 445.5 | 0.96% |
| 800 | 556 | 0.96% |
| 986 | 682 | 0.48% |
| 1159 | 800 | 0.27% |
| 1280 | 881 | −0.02% |
| 1463 | 1004 | −0.31% |
| 1580 | 1080 | −0.71% |

TABLE 4
the results of Test 3

| Primary current (A) | Secondary voltage (mV) | Error (%) |
|---|---|---|
| 16 | 8.6 | −0.20% |
| 32.4 | 17.6 | 0.86% |
| 47.2 | 25.5 | 0.31% |
| 64.4 | 34.7 | 0.04% |
| 79.6 | 43 | 0.30% |
| 96.2 | 51.9 | 0.17% |
| 112.4 | 60.5 | −0.06% |
| 128.4 | 69 | −0.23% |
| 148 | 79.4 | −0.39% |
| 161.4 | 86.9 | −0.03% |
| 320.6 | 172.3 | −0.22% |
| 480.2 | 257.7 | −0.36% |
| 639 | 343 | −0.34% |
| 801 | 430.2 | −0.28% |
| 962 | 517 | −0.22% |
| 1152 | 619 | −0.24% |
| 1276 | 689 | 0.25% |
| 1431 | 772 | 0.16% |
| 1620 | 873 | 0.05% |

TABLE 5
the results of Test 4

| Primary current (A) | Secondary voltage (mV) | Error (%) |
|---|---|---|
| 16 | 7.8 | 4.59% |
| 32.12 | 15.3 | 2.20% |
| 48.18 | 22.5 | 0.19% |
| 64.1 | 30 | 0.41% |
| 80.06 | 37.2 | −0.31% |
| 96.42 | 45 | 0.13% |
| 113.26 | 53 | 0.40% |
| 127.6 | 59.3 | −0.29% |
| 144.6 | 66.5 | −1.33% |
| 160.4 | 74.5 | −0.35% |
| 322.2 | 149 | −0.78% |
| 480 | 225 | 0.57% |
| 644 | 302 | 0.61% |
| 795 | 372 | 0.39% |
| 970 | 453 | 0.20% |
| 1148 | 536 | 0.17% |
| 1272 | 594 | 0.19% |
| 1448 | 676 | 0.16% |
| 1566 | 730 | 0.01% |
| 1689 | 783 | −0.54% |

TABLE 6
The results of test 5

| Primary current (A) | Secondary voltage (mV) | Error (%) |
|---|---|---|
| 16 | 4.8 | −0.27% |
| 32.2 | 9.7 | 0.15% |
| 47.2 | 14.4 | 1.42% |
| 64 | 19.5 | 1.29% |
| 80 | 24.4 | 1.40% |
| 96.2 | 29.2 | 0.91% |
| 112.8 | 34.2 | 0.80% |
| 128.4 | 39 | 0.98% |
| 145.8 | 44.2 | 0.78% |
| 160.8 | 48.8 | 0.89% |
| 320.8 | 97 | 0.52% |
| 478.8 | 144.6 | 0.40% |
| 639 | 192.8 | 0.31% |
| 800 | 240.8 | 0.07% |
| 961 | 289.4 | 0.11% |
| 1127 | 339.5 | 0.15% |
| 1270 | 381.5 | −0.14% |
| 1448 | 435.4 | −0.04% |
| 1566 | 471.1 | 0.01% |
| 1669 | 501 | −0.21% |

TABLE 7
The results of test 6

| Primary current (A) | Secondary voltage (mV) | Error (%) |
|---|---|---|
| 16 | 4.5 | −0.97% |
| 32.2 | 9.2 | 0.60% |
| 47 | 13.5 | 1.14% |
| 64 | 18.5 | 1.78% |
| 80 | 23.1 | 1.67% |
| 96 | 27.6 | 1.23% |
| 111.4 | 32 | 1.15% |
| 129.8 | 37.3 | 1.18% |
| 143.8 | 41.4 | 1.37% |
| 160.6 | 46.2 | 1.29% |
| 320.6 | 91.9 | 0.93% |
| 481.4 | 137.4 | 0.50% |
| 641 | 183.4 | 0.74% |
| 801 | 229.2 | 0.75% |
| 965 | 275.5 | 0.53% |
| 1112 | 316.7 | 0.28% |
| 1271 | 360.8 | −0.05% |
| 1443 | 409.6 | −0.05% |
| 1583 | 448.3 | −0.28% |
| 1631 | 461.5 | −0.37% |

The test results of Tests 1 to 6 shown in Tables 2 to 7 illustrate the discrete values of the secondary voltage changing with the changes of the primary current under conditions of each set of tests shown in Table 1; in order to make the test results to be shown in a more illustrative manner on a coordinate system, the primary current is on the x axis, and the secondary voltage is on the y axis, linear trendlines are added to the each set of discrete values, and the intercept of each trendline is put to 0 (namely, the trendlines pass the origin point). The trendline equation and correlation coefficient R² of each trendline are shown in the following table (prepared by using Excel):

TABLE 8
Trendline equation and correlation coefficient R² of each trendline

| | | Correlation |
|---|---|---|
| Each set of tests | Trendline equations | coefficients R² |
| Test 1 | y = 0.8456x | 1 |
| Test 2 | y = 0.6884x | 0.9999 |
| Test 3 | y = 0.5386x | 1 |
| Test 4 | y = 0.4661x | 1 |
| Test 5 | y = 0.3008x | 1 |
| Test 6 | y = 0.284x | 1 |

The correlation coefficients R² with the value range [0, 1] reflect the fitting degree of the trendlines to the test data, and the larger these values are the higher the fitting degree, and the higher the linearity of trendlines. FIG. 8 shows a trendline diagram of the primary current versus the secondary voltage of each set of tests, and it can be seen from the figure that all the test results of Tests 1 to 6 (the secondary voltage output signals) have good linearity in the induction range (primary current range) [16A, 1600A], and furthermore the linearity of the secondary voltage output signals is not affected by the number of turns of the secondary coils and the size of the value of the load resistance connected to the secondary coils. Particularly, in the case of a high primary current (1600 A), none of the test results of Tests 1 to 6 shows the saturation or a tendency to saturation, and therefore it can be inferred reasonably that, even in a case of a higher primary current, the large current sensor of the present invention would still maintain a good linearity.

Similarly, the size of the amplitude of the secondary voltage output signal is also an important parameter for a large current measurement device, and the output signal having a small amplitude is not only prone to interference, but also results in the subsequent signal processing circuits not being able to process the signal or needing to have it amplified first by an amplifying circuit before performing the subsequent signal processing.

TABLE 9
Minimum secondary voltage of each set of
tests when the primary current was 16 A

| | Each set of tests | | | | | |
|---|---|---|---|---|---|---|
| | Test 1 | Test 2 | Test 3 | Test 4 | Test 5 | Test 6 |
| Second voltage | 13.6 | 11.3 | 8.6 | 7.8 | 4.8 | 4.5 |
| (mV) | | | | | | |

It can be seen from Table 9 that, when the minimum primary current was 16 A, the second voltage output from each set of tests was still relatively large, and was able to meet the processing requirements of the subsequent signal processing circuits.

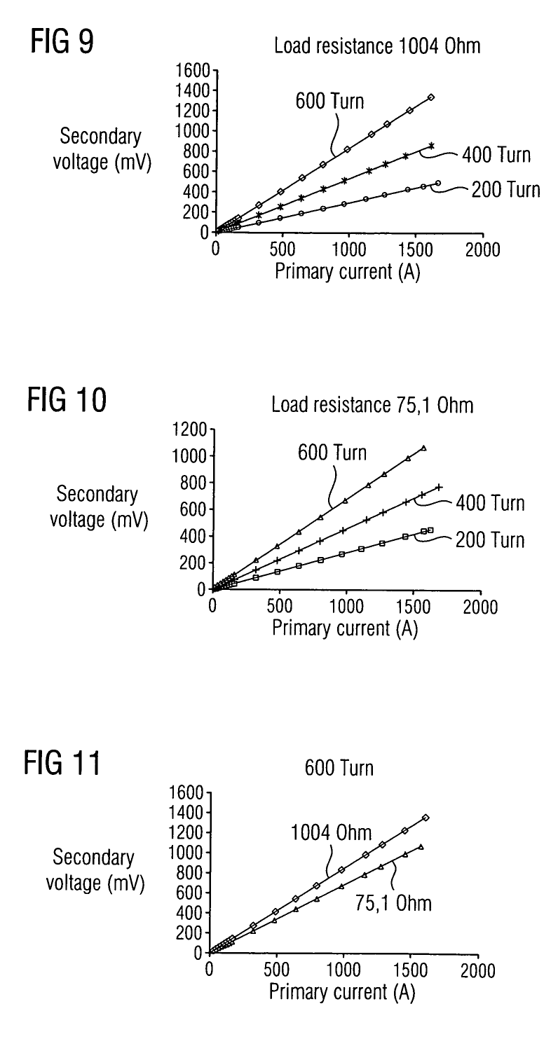

The amplitude of the secondary voltage output signal is mainly affected by the number of turns of the secondary coil, and FIGS. 9 and 10 show respectively the diagrams of the primary current versus the secondary voltage in which the numbers of turns of the secondary coils are respectively 600 turns, 400 turns and 200 turns when the load resistances are 1004 Ohm and 75.1 Ohm respectively. It can be seen from the figures that, under the conditions of the same load resistance and the same primary current, the amplitude of output signal of the secondary voltage increases with the increase of the number of turns of the secondary coil.

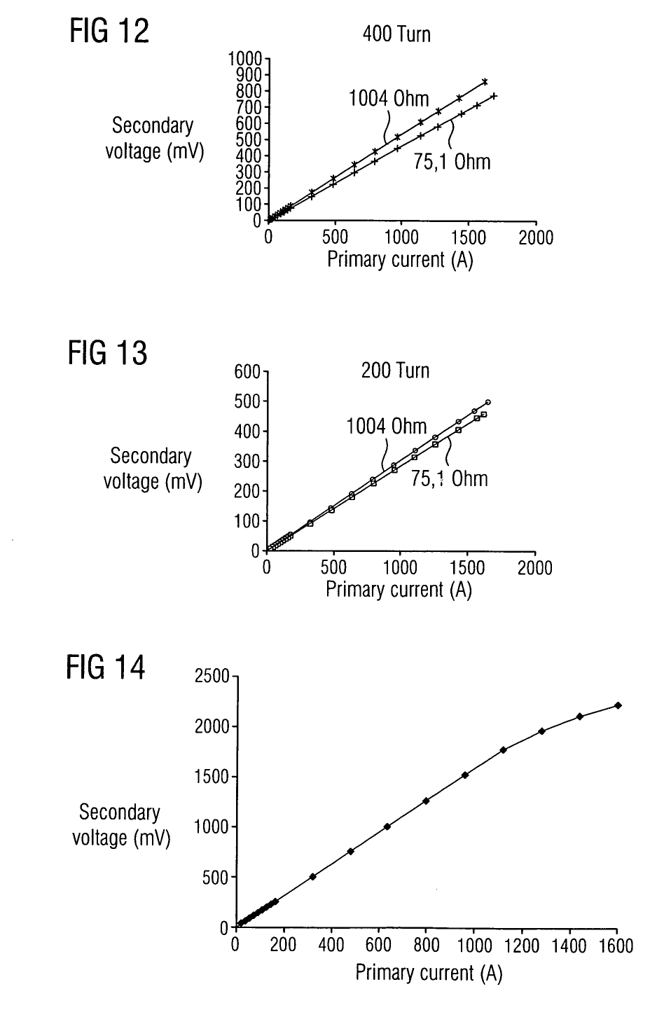

The amplitude of output signal of the secondary voltage is also affected by the size of load resistance connected to the secondary coil, and FIG. 11, FIG. 12, and FIG. 13 show respectively the diagrams of the primary current versus the secondary voltage in which the load resistances are 1004 Ohm and 75.1 Ohm respectively when the numbers of turns of the secondary coil are 600 turns, 400 turns, and 200 turns respectively. It can be seen from the figures that, under the conditions of the same number of turns of the secondary coil and same primary current, the amplitude of output signal of the secondary voltage increases with the increase of the value of the load resistance.

Therefore, the amplitude of the output signal of the large current sensor of the present invention can be adjusted by adjusting the number of turns of the secondary coil and the value of the load resistance so as to meet the requirements of different signal processing circuits.

In order to compare with the currently available large current measurement devices, the applicant has also performed the similar tests on a transformer that is commercially available and has relatively good performances, so as to study the linearity and accuracy of the current signal outputted by its secondary coil, and the test results are as follows:

TABLE 10
The test results of a currently available current transformer

| Primary current (A) | Secondary current (mA) | Error (%) |
|---|---|---|
| 16 | 24 | −4.00% |
| 32 | 49 | −2.00% |
| 48 | 73 | −2.67% |
| 64 | 99 | −1.00% |
| 80 | 123 | −1.60% |
| 96 | 148 | −1.33% |
| 112 | 173 | −1.14% |
| 128 | 198 | −1.00% |
| 144 | 223 | −0.89% |
| 160 | 246 | −1.60% |
| 320 | 497 | −0.60% |
| 480 | 748 | −0.27% |
| 640 | 1000 | 0.00% |
| 800 | 1252 | 0.16% |
| 960 | 1512 | 0.80% |
| 1120 | 1764 | 0.80% |
| 1280 | 1953 | −2.35% |
| 1440 | 2102 | −6.58% |
| 1600 | 2213 | −11.48% |

FIG. 14 shows the diagram of the primary current versus the secondary voltage of the currently available current transformer corresponding to Table 10. It can be seen from the figure that, when the primary current is relatively low, for example less than 1300 A, the output signal of the secondary current has quite good linearity; however, when the primary current becomes higher, for example more than 1300 A, saturation occurs to the secondary coil, and the linearity of the output signal of the secondary current deteriorates significantly and appears in an increasing tendency, and this will seriously affect the measurement accuracy of the current transformer.

The accuracy of the output signal of the large current sensor according to an embodiment of the present invention is measured by the signal error, and the smaller the error, the higher the accuracy; otherwise, the lower the accuracy. The method for calculating the error is that, at a specific primary current value, the ratio of the difference between the measurement value of the secondary voltage and the standard value of secondary voltage obtained by introducing the primary current value into the trendline equation to the standard value of the secondary voltage is expressed as a percentage. For example, in Test 1, when the primary current is 16A, the measured value of the secondary voltage is 13.6 mV, in the trendline equation y=0.8456x (with the primary current on the x-axis, and the second voltage on the y-axis); the primary current value x=16 is introduced into the trendline equation to get the standard value of second voltage y=13.5296 (mV), and the difference between the measurement value of the secondary voltage and the standard value of the secondary voltage is 0.0704 mV, and then at this specific primary current value, the error of output signal of the second voltage is (0.0704/13.5296)*100%=0.52%.

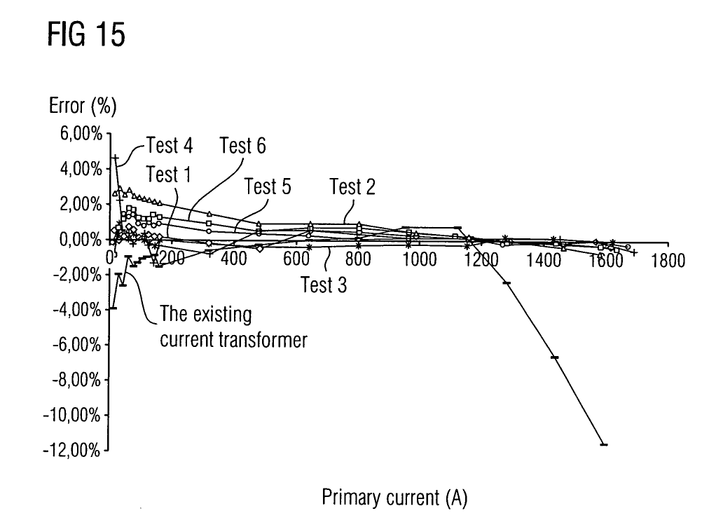

By referring to the error values of the output signal in each set of tests for the large current sensor of an embodiment of the present invention in Tables 2 to 7, and the error values of output signal of the currently available current transformer in Table 10, and at the same time referring to the diagram of the corresponding primary current versus the error as shown in FIG. 15, it can be seen that, within quite wide a range of the primary current (0-1600A), all the error values of the output signal of each set of tests by the large current sensor of an embodiment of the present invention are comparatively ideal, and among them, the error values of Tests 1, 3, and 5 are all within ±1% of the range of the primary current, while among Tests 2, 4, and 6, only one of them has the error value higher than 4% and the others are within ±3%; furthermore, the higher the primary current, the smaller the error value; particularly, when the primary current is around 1600A, all the error values of Tests 1 to 6 are within ±1%. The error value of the output signal by the currently available current transformer remains within a small range when the primary current is relatively low; however, with the increase of the primary current, for example beyond 1300 A, the error value rises sharply, for example when the primary current is 1560 A, the error value reaches −11.7%, which corresponds to the abovementioned sharp deterioration of the linearity of the output signal from the current transformer when the primary current is beyond 1300 A.

The following conclusions can be made from the above test data and the relevant analysis:

The output signal of the large current sensor of an embodiment of the present invention has good linearity and accuracy within quite wide a range of the primary current.

The amplitude of the output signal of the large current sensor according to an embodiment of the present invention meets the requirements of the circuits for subsequent signal processing, and the size of the amplitude of the output signal can be adjusted by adjusting the number of turns of the secondary coil and the value of the load resistance.

The large current sensor of an embodiment of the present invention is particularly suitable to the measurement of a large current.

What are described above are merely preferred embodiments of the present invention, and are not to limit the present invention; any modification, equivalent replacement and improvement within the spirit and principle of the present invention should be included in the protection scope of the present invention.

The patent claims filed with the application are formulation proposals without prejudice for obtaining more extensive patent protection. The applicant reserves the right to claim even further combinations of features previously disclosed only in the description and/or drawings.

The example embodiment or each example embodiment should not be understood as a restriction of the invention. Rather, numerous variations and modifications are possible in the context of the present disclosure, in particular those variants and combinations which can be inferred by the person skilled in the art with regard to achieving the object for example by combination or modification of individual features or elements or method steps that are described in connection with the general or specific part of the description and are contained in the claims and/or the drawings, and, by way of combineable features, lead to a new subject matter or to new method steps or sequences of method steps, including insofar as they concern production, testing and operating methods.

References back that are used in dependent claims indicate the further embodiment of the subject matter of the main claim by way of the features of the respective dependent claim; they should not be understood as dispensing with obtaining independent protection of the subject matter for the combinations of features in the referred-back dependent claims. Furthermore, with regard to interpreting the claims, where a feature is concretized in more specific detail in a subordinate claim, it should be assumed that such a restriction is not present in the respective preceding claims.

Since the subject matter of the dependent claims in relation to the prior art on the priority date may form separate and independent inventions, the applicant reserves the right to make them the subject matter of independent claims or divisional declarations. They may furthermore also contain independent inventions which have a configuration that is independent of the subject matters of the preceding dependent claims.

Further, elements and/or features of different example embodiments may be combined with each other and/or substituted for each other within the scope of this disclosure and appended claims.

Example embodiments being thus described, it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. A current sensor comprising:
a primary coil including at least one spiral turn; and
a secondary coil, wherein a secondary voltage is induced in the secondary coil when a primary current flows through the primary coil, the at least one spiral turn being formed from a flat electrical conductor, a face of the flat electrical conductor, facing an interior of the at least one spiral turn, forming a chamber in which the secondary coil is arranged.

2. The large current sensor as claimed in claim 1, wherein a rapid saturation current transformer is provided at one end of said primary coil.

3. The large current sensor as claimed in claim 1, wherein said cavity extends along a direction of a spiral axis of said primary coil.

4. The large current sensor as claimed in claim 1, wherein said primary coil is formed by twisting a copper busbar.

5. The large current sensor as claimed in claim 1, wherein said primary coil is a single-turn or multiple-turn coil.

6. The large current sensor as claimed in claim 1, wherein said secondary coil is a multiple-turn coil.

7. The large current sensor as claimed in claim 6, wherein said secondary coil is an air core coil.

8. The large current sensor as claimed in claim 6, characterized in that said secondary coil is one wound on a non-ferromagnetic core.

9. The large current sensor as claimed in claim 2, wherein said primary coil is formed by twisting a copper busbar.

10. The large current sensor as claimed in claim 2, wherein said primary coil is a single-turn or multiple-turn coil.

11. The large current sensor as claimed in claim 3, wherein said primary coil is formed by twisting a copper busbar.

12. The large current sensor as claimed in claim 3, wherein said primary coil is a single-turn or multiple-turn coil.

13. The large current sensor as claimed in claim 5, wherein said secondary coil is a multiple-turn coil.

14. The large current sensor as claimed in claim 10, wherein said secondary coil is a multiple-turn coil.

15. The large current sensor as claimed in claim 12, wherein said secondary coil is a multiple-turn coil.

16. The large current sensor as claimed in claim 13, wherein said secondary coil is an air core coil.

17. The large current sensor as claimed in claim 13, characterized in that said secondary coil is one wound on a non-ferromagnetic core.

18. The large current sensor as claimed in claim 14, wherein said secondary coil is an air core coil.

19. The large current sensor as claimed in claim 14, characterized in that said secondary coil is one wound on a non-ferromagnetic core.

20. The large current sensor as claimed in claim 15, wherein said secondary coil is an air core coil.

21. The large current sensor as claimed in claim 15, characterized in that said secondary coil is one wound on a non-ferromagnetic core.
